(19) United States
(12) Patent Application Publication
(10) Pub. No.: US 2005/0027997 A1
(43) Pub. Date: Feb. 3, 2005

(54) Protection key and a method for reissuance of a protection key

(75) Inventors: Osamu Ueno, Shizuoka-ken (JP); Yoshikazu Nishino, Shizuoka-ken (JP); Fumiaki Nishiyama, Shizuoka-ken (JP); Rei Isogai, Shizuoka-ken (JP); Yasunori Kitajima, Shizuoka-ken (JP); Miho Urano, Shizuoka-ken (JP)

Correspondence Address: Finnegan, Henderson, Farabow,;Garrett & Dunner, L.L.P., 1300 I Street, N.W., Washington, DC, 20005-3315, US

(73) Assignee: YAZAKI CORPORATION

(21) Appl. No.: 10/900,305

(22) Filed: Jul. 28, 2004

(30) Foreign Application Priority Data
Jul. 29, 2003 (JP) P2003-281981

(51) Int. Cl. G06F 12/14

(52) U.S. Cl. 713/193

(57) ABSTRACT

A protection key provided with an information processor includes a memory unit including a first storage area to store first data used for permission to use of software installed in the information processor and a second storage area to store second data, the second data being the same as the data stored in another protection key for permission to use other software installed in the information processor, and a controller configured to determine whether the second data is valid, wherein the controller transmits the second data to the information processor when the second data is valid and transmits the first data to the information processor when the second data is invalid.

### CROSS REFERENCE TO RELATED APPLICATIONS

This application is based upon and claims the benefit of priority from prior Japanese Patent Application P2003-281981 filed on Jul. 29, 2003; the entire contents of which are incorporated by reference herein.

### BACKGROUND OF THE INVENTION

1. Field of the Invention

The present invention relates to a protection key for hardware and a method for reissuance of a protection key, especially a technology for reissuance of a lost protection key.

2. Description of the Related Art

A protection key, called a “dongle,” is used to prevent illegal copying of software. The dongle is connected to an I/O port of a computer through a connector. The dongle is unique for the software, so the software can not accept other dongles to run the software. Also, the software does not run unless the dongle is connected to the computer. A universal serial bus (USB) interface is well-known as a connection for computer peripherals whose data transfer speed is relatively low, such as a keyboard, a mouse, a speaker, a modem, or a printer, or the like. The USB interface is used as the connection for the protection key so as to provide portability for the key.

The computer identifies an authorized dongle, and then the computer runs the software. The dongle includes “dongle data”, for example, a serial number, a product identification of the software, or a company identification provided by the company, so that the computer can determine whether to grant permission for the use of the software. When the computer grants permission to use the software, the software matching the dongle data can be used. When the dongle is connected to the computer, the computer retrieves key information from the dongle, generates a cryptography key, based on the key information, by an encryption algorithm, and encrypts the general data based on the cryptography key so as to transmit the general data to the computer peripherals.

As shown in Japanese laid open (Kokai) No. 2000-151580, a Digital Block Cipher based on a Chaos Block Cipher Algorithm is known as cryptography technology. Also, well-known cryptography technology is shown in Japanese laid open (Kokai) No. 2001-175468 and No. 2002-116837.

### SUMMARY OF THE INVENTION

If the protection key is lost or damaged because of its portability, another protection key having different dongle data from the lost or damaged dongle, is reissued. However, the users of the software may want to use the same dongle data rather than to change the dongle data by reinstalling the software. If the protection key is damaged to such an extent that is can not function, the users may not be concerned about security of the computer. Then, it is an object of the present invention to provide the protection key for hardware and a method for reissuance of a protection key including the same dongle data.

An aspect of the present invention inheres in a protection key provided with an information processor including a memory unit including a first storage area to store first data used for permission to use of software installed in the information processor and a second storage area to store second data, the second data being the same as the data stored in another protection key for permission to use other software installed in the information processor, and a controller configured to determine whether the second data is valid, wherein the controller transmits the second data to the information processor when the second data is valid and transmits the first data to the information processor when the second data is invalid.

An another aspect of the present invention inheres in a method for reissuance of a protection key provided with an information processor including storing first data in a first storage area of a memory unit in the protection key, the first data used for permission to use software installed in the information processor, storing second data in a second storage area of the memory, the second data being the same as data stored in another protection key for permission to use other software installed in the information processor, determining whether the second data is valid, transmitting the second data to the information processor when the second data is valid, and transmitting the first data to the information processor when the second data is invalid.

### BRIEF DESCRIPTION OF THE DRAWINGS

FIG. 1 is a block diagram schematically showing the protection key of the first embodiment of the present invention.

FIG. 2 is a view schematically showing the storage area of the memory unit in the protection key of the first embodiment.

FIG. 3 is a sequence chart schematically showing the operation of the first embodiment.

FIG. 4 is a block diagram schematically showing the protection key of the second embodiment of the present invention.

FIG. 5 is a view schematically showing the storage area of the memory unit in the protection key of the second embodiment.

FIG. 6 is a view schematically showing the waveform of the chaos time series based on the logistic mapping.

FIG. 7 is a sequence chart schematically showing the operation of the second embodiment.

FIG. 8 is a view schematically showing the EXCLUSIVE-OR operation.

### DETAILED DESCRIPTION OF EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following description specific details are set fourth, such as specific materials, process and equipment in order to provide thorough understanding of the present invention. It will be apparent, however, to one skilled in the art that the present invention may be practiced without these specific details. In other instances, well-known manufacturing materials, process and equipment are not set fourth in detail in order not unnecessary obscure the present invention.

Embodiments are set forth below with reference to figures. The USB key set below as a protection key can be replaced by another interface.

(FIRST EMBODIMENT)

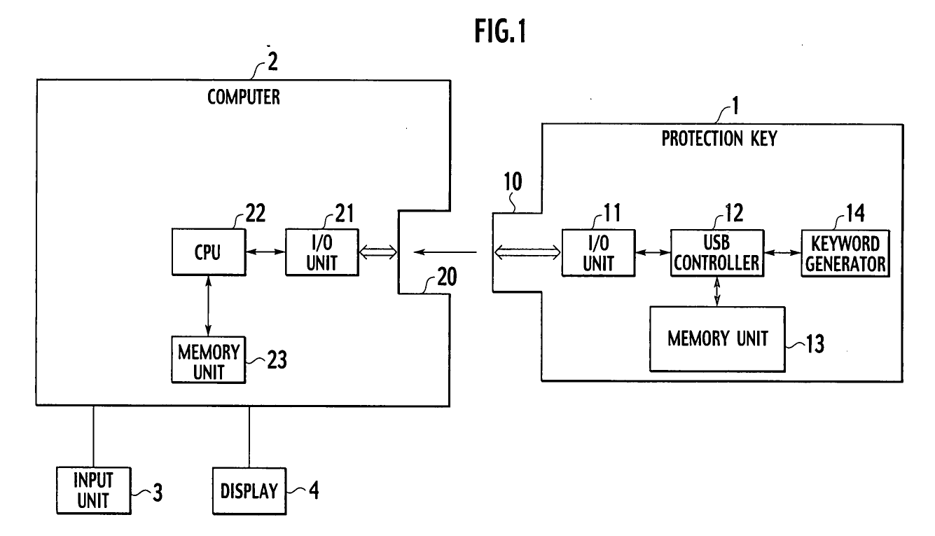

As shown in FIG. 1, an information system includes a computer 2 and a USB key (a protection key) 1 configured to connect with the computer 2. The computer 2 corresponds to an information processor of the present invention. The computer 2 may be a personal computer, a mobile device such as a mobile phone or a PDA, a server computer, a workstation, or another type of information processor. The USB key 1 corresponds to a reissued protection key of the present invention. The USB key 1 is reissued to replace a previous protection key which has been lost or damaged. The USB key 1 includes a USB connector 10 connecting with another connector 20 provided in the computer 2. The USB key 1 and the computer 2 are interconnected electrically for data communication.

The USB key 1 includes an I/O port 11, a USB controller 12, and a memory unit 13. The I/O port 11 includes a USB interface circuit to control data transfer between the USB key 1 and the computer 2. For example, the I/O port 11 receives data from the computer 2, transmits the data to the USB controller 12, and controls a transfer of the data between the USB key 1 and the computer 2. The USB controller 12 includes a CPU to control each unit in the USB key 1. For example, the USB controller 12 receives an acquisition request for the data from the computer 2, retrieves the data according to the acquisition request, and transmits the data to the computer 2 through the I/O port 11.

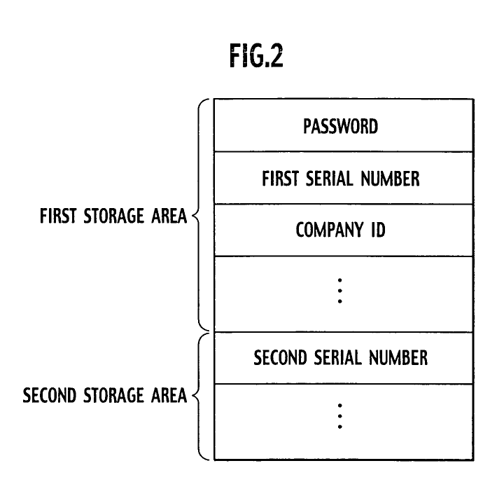

The memory unit 13 includes a ROM, such as EEPROM. As shown in FIG. 2, a storage area of the memory unit 13 includes a first storage area to store a password, a first serial number, and a company identification and a second storage area to store a second serial number. The password, the first serial number, and the company identification are initially written in the USB key 1 packaged with the software. Generally, the password includes a series of digits and/or symbols. Generally, the first serial number is a unique product number according to the USB key 1. The product number includes a series of digits and/or symbols. Generally, the company identification includes a series of digits and/or symbols provided by a software company to a company.

The second storage area in the memory unit 13 stores the second serial number, which includes the same dongle data as the previous protection key. The data in the memory unit 13 is retrieved by the USB controller 12 and rewritten by the USB controller 12. A memory unit in the USB controller 12 may be used as the memory unit 13.

As shown in FIG. 1, the computer 2 includes an I/O port 21, a CPU 22, and the memory unit 23. An input unit 3 and a display 4 are connected with the computer 2. The I/O port 21 includes a USB interface circuit complying with the USB interface standard to control data transfer to the USB key 1. For example, the I/O port 21 transmits the data to the CPU 22 from the USB key 1, and transmits the data to the USB key 1 from the CPU 22. The CPU 22 includes a processor to control each unit in the computer 2. For example, the CPU 22 transmits the data according to acquisition requests to the USB key 1 provided with the computer 2, checks at least one of the password, the first serial number, the second serial number, and the company identification, and enables the software to be used. The memory unit 23 stores the password and other general data supplied from the input unit 3. The CPU 22 accesses the memory unit 23.

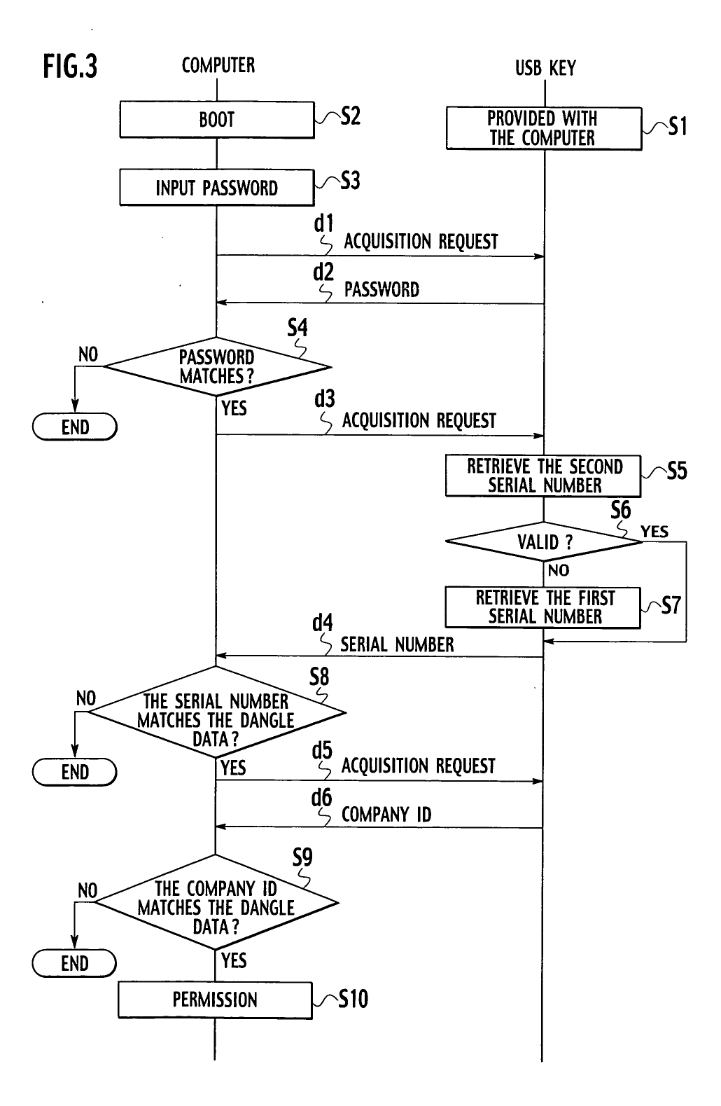

Operation of an information management system for reissuance of the protection key 1 according to the first embodiment is set forth below with reference to FIG. 3. In the step S1, the USB key 1 is connected with the computer 2. In the step S2, the computer 2 is booted. In the step S3, the password is supplied to the computer 2 by the input unit 3. In the action d1, the computer 2 transmits the data according to an acquisition request for the password. In the action d2, the USB controller 12 in the USB key 1 receives the acquisition request and retrieves the password stored in the memory unit 13 to transmit the password to the computer 2.

In the step S4, the CPU 22 in the computer 2 determines whether the password supplied from the input unit 3 matches the password supplied from the USB key 1. When both of the passwords do not match each other, the operation of the information management system is terminated. When both of the passwords match each other, in the action d3, the computer 2 transmits the acquisition request for the serial number to the USB key 1. In the step S5, the USB key 1 receives the acquisition request for the serial number, and retrieves the second serial number stored in the second storage area of the memory unit 13. In the step S6, the USB key 1 determines whether the second serial number is valid. For example, if all digits are “1”, the serial number is determined to be invalid. If no data is stored in the second storage area, the serial number is determined to be invalid. When the second serial number is invalid, the USB key 1 retrieves the first serial number from the memory unit 13 in the step S7.

In the action d4, the USB key 1 transmits the first serial number or the second serial number to the computer 2. That is, the valid second serial number is transmitted to the computer 2. In the step S8, the computer 2 determines whether the transmitted serial number, that is, the first serial number or the second serial number, matches the dongle data according to the software. That is, the CPU 22 in the computer 2 determines whether the transmitted serial number matches the dongle data included in the software. When the serial number transmitted from the USB key 1 does not match the dongle data according to the software, the operation of the information management system is terminated. When the serial number transmitted from the USB key 1 matches the dongle data according to the software, the computer 2 transmits the data according to the acquisition request for the company identification to the USB key 1 in the action d5. Then, the USB controller 12 in the USB key 1 retrieves the company identification from the memory unit 13 and transmits the company identification to the computer 2 in the action d6.

In the step S9, the computer 2 determines whether the company identification matches the dongle data according to the software. That is, the CPU 22 in the computer 2 determines whether the transmitted company identification matches the dongle data included in the software. When the company identification transmitted from the USB key 1 does not match the dongle data according to the software, the operation of the information management system is terminated. When the company identification transmitted from the USB key 1 matches the dongle data according to the software, in the step S10, the computer 2 grants permission for the use of the software. That is, when the computer 2 identifies the allowed dongle data, then the computer 2 permits the software to run.

Thus, according to the first embodiment, the USB key 1 is reissued, storing the dongle data in the second storage area in addition to the dongle data stored in the first storage area. Consequently, it is easy to reissue the protection key without changing the dongle data according to the software.

(SECOND EMBODIMENT)

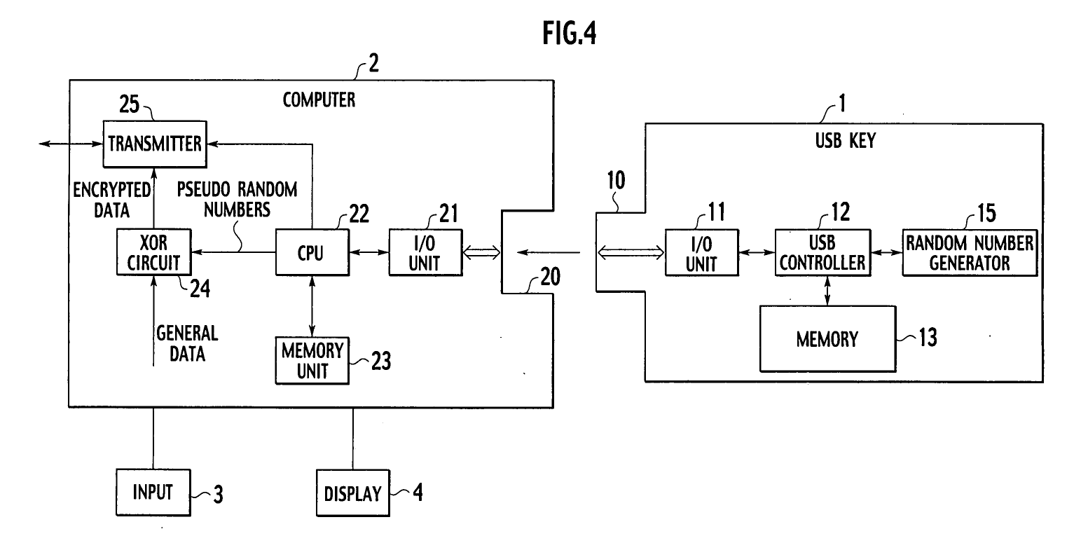

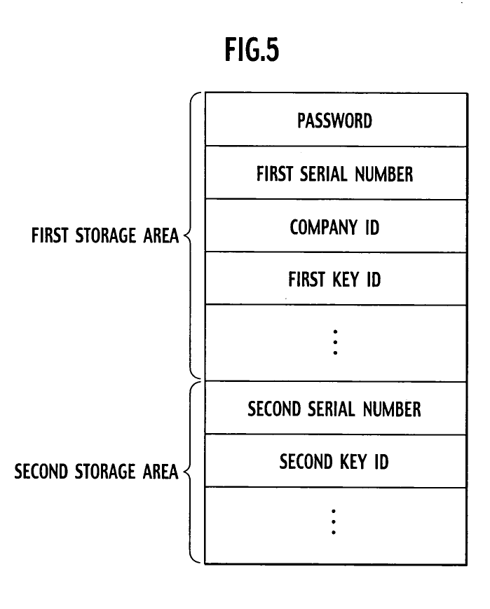

As shown in FIG. 4, in the second embodiment, the USB key 1 further includes a random number generator 15. The random number generator 15 generates a plurality of pseudo random numbers based on a chaos time series. The USB controller 12 receives data according to data size (number of bytes) of the general data supplied from the input unit 3 through the computer 2 and transmits an encryption key including the pseudo random numbers generated by the random number generator 15. As shown in FIG. 5, the memory unit 13 further includes a first key identification in the first storage area and a second key identification in the second storage area. The first key identification and the second key identification are initial values of a chaos function set forth below. The second storage area in the memory unit 13 stores the second key identification, which includes the same dongle data as the previous protection key.

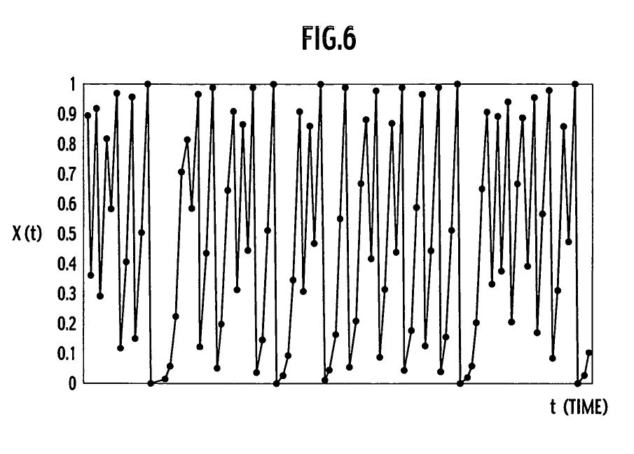

The pseudo random number generator 15 generates the pseudo random numbers based on data size of the general data, a chaos function, and an initial value of the chaos function. The pseudo numbers are generated based on a chaos time series. A logistic mapping is one of the basic models for the chaos time series. For example, a formula of the logistic mapping is shown in the following recurrence formula (1).
X(t+1)=4X(t){1−X(t)}X(t)=X(t+1) (1)
The “t” represents discrete time and “X(t)” represents a chaos function. An initial value “X(0)” is given in the formula (1), and then the discrete time “t” increases at a rate of ,,t, for example from 0 to 100. Finally, as shown in FIG. 6, the chaos time series of the logistic mapping, {X(t)−t} is given. In FIG. 6, the chaos function “X(t)” is plotted at a rate of a given ,,t. According to the formula of the logistic mapping, a value of the chaos function shows a rise and fall, such as in a waveform. The waveform is susceptible to the initial value “X(0)”, that is, the value of the chaos function is subject to extreme changes in accordance with even a small change of the initial value. Therefore, many varieties of sets of the pseudo random numbers are generated by changing the initial value. The formula of the logistic mapping is nonlinear because of a nonlinear I/O characteristic. The value of the chaos function “X(t)” is noninvertible because of its nonrepeatability. Therefore, the value of the chaos function cannot be easily determined, thereby enhancing confidentiality of the data.

The computer 2 also includes an EXCLUSIVE-OR circuit (an XOR circuit) 24 and a transmitter 25. The CPU 22 transmits data size of the general data to the USB key 1 provided with the computer 2. The CPU 22 also transmits the pseudo random numbers to the XOR circuit 24 from the USB key 1, determines whether the dongle data transmitted from the USB key 1, that is the password, the first serial number, the second serial number, or the company identification, matches the dongle data according to the software. When the two pieces of dongle data match each other, the CPU 22 grants permission to encrypt the general data. The CPU 22 accesses the memory unit 23. The XOR circuit 24 performs an EXCLUSIVE-OR operation based on the pseudo random numbers and the general data to encrypt the general data. The XOR circuit 24 transmits the encrypted general data to the transmitter 25. The transmitter 25 transmits the encrypted general data to computer peripherals.

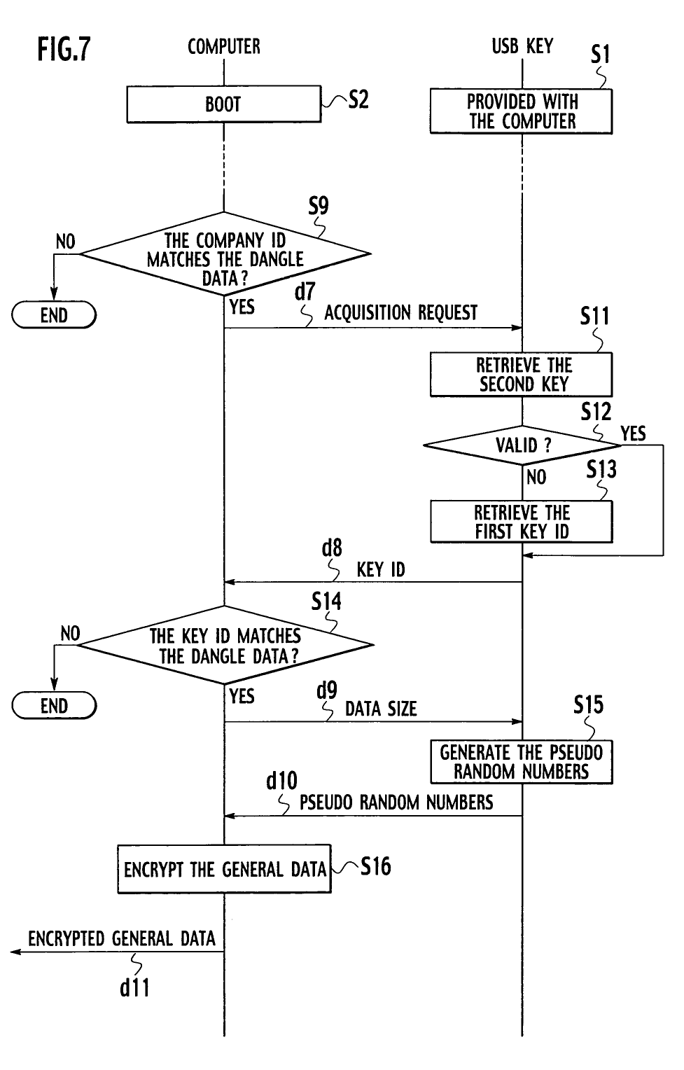

An operation of an information management system for reissuance of the protection key 1 according to the second embodiment is set forth below with reference to FIG. 7. In the second embodiment, the steps S1 to S9 and the actions d1 to d6 are the same as the steps and the actions in the first embodiment as shown in FIG. 3. In the step S9, when the company identification transmitted from the USB key 1 does not match the dongle data according to the software, the CPU 22 transmits an acquisition request for the key identification in the action d7. In the step S11, the USB key 1 receives the acquisition request, retrieving the second key identification stored in the second storage area of the memory unit 13. In the step S12, the USB key 1 determines whether the second key identification is valid. For example, if all digits are “1”, the serial number is determined to be invalid. If no data is stored in the second storage area, the serial number is determined to be invalid. When the second key identification is invalid, in the step S13, the USB key 1 retrieves the first key identification from the memory unit 13.

In the action d8, the USB key 1 transmits the first key identification or the second key identification to the computer 2. That is, the valid second key identification is transmitted to the computer 2. In the step S14, the computer 2 determines whether transmitted key identification, that is, the first key identification or the second key identification, matches the dongle data according to the software. That is, the CPU 22 in the computer 2 determines whether the transmitted key identification matches the dongle data included in the software. When the key identification transmitted from the USB key 1 does not match the dongle data according to the software, the operation of the information management system is terminated. When the key identification transmitted from the USB key 1 matches the dongle data according to the software, in the action d9, the computer 2 transmits data size of the general data to the USB key 1 so as to encrypt the general data.

In the step S15, the random number generator 15 generates the pseudo random numbers based on the data size, the chaos function, and the initial value of the chaos function, that is, the first key identification or the second key identification. In the action d10, the USB controller 12 transmits the pseudo random numbers as a keyword to the computer 2.

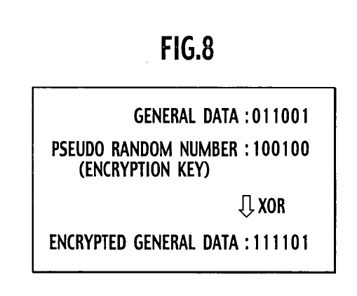

The CPU 22 supplies the pseudo random numbers to the XOR circuit 24. In the step S16, the XOR circuit 24 performs the EXCLUSIVE-OR operation to encrypt the general data and transmits the encrypted general data to the transmitter 25. For example, as shown in FIG. 8, the general data shows “011001” and the pseudo random numbers shows “100100”. After the EXCLUSIVE-OR operation, the encrypted general data, for example, “111101” is generated by the random number generator 15. The transmitter 25 transmits the encrypted general data to the computer peripherals. The encrypted general data is stored in the memory unit 23.

According to the second embodiment, the USB key 1 is reissued, storing the dongle data in the second storage area in addition to the dongle data stored in the first storage area. Consequently, it is easy to reissue the protection key without changing the dongle data according to the software.

The random number generator 15 provided in the USB key 1 generates the pseudo random numbers on request of the computer 2 for encrypting the general data. That is, the random number generator 15 is not provided in the computer 2 so that the pseudo random numbers or an encryption algorithm can not be easily decrypted by other users. Consequently, confidentiality of data is enhanced. Once the USB key 1 is provided with the computer 2, the general data including text data and image data is encrypted. The computer 2 provided with the USB key 1 can communicate in encrypted data with another computer provided with another USB key. Because the random number generator 15 is provided in the USB key 1, not in the computer 2, the CPU load of the computer 2 for generating the random numbers decreases. Confidentiality of the data increases for the password, the serial number, the company identification, and the key identification matched with those stored in the computer 2. Changing the initial value of the chaos function permits many types of the USB keys to be used among a plurality of user groups. According to the present invention, the pseudo random numbers are generated quickly, compared with a Data Encryption Standard basis which is a well-known encryption method.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein.

1. A protection key provided with an information processor, comprising:
a memory unit including a first storage area to store first data used for permission to use of software installed in the information processor and a second storage area to store second data, the second data being the same as the data stored in another protection key for permission to use other software installed in the information processor; and
a controller configured to determine whether the second data is valid, wherein the controller transmits the second data to the information processor when the second data is valid and transmits the first data to the information processor when the second data is invalid.

2. The protection key of claim 1, wherein
the first data is a unique product number according to the protection key, and
the second data is a unique dongle data for the other software.

3. The protection key of claim 1, wherein
the first data is a first key identification which is an initial value of a chaos function for the software, and
the second data is a second key identification which is another initial value of the chaos function for the other software.

4. The protection key of claim 3, further comprising:
a random number generator configured to generate a plurality of pseudo random numbers based on the chaos function, wherein
the controller transmits an encryption key including the pseudo random numbers generated based on one initial value of the first key identification and the second key identification for the chaos function to the information processor.

5. A method for reissuance of a protection key provided with an information processor, comprising:
storing first data in a first storage area of a memory unit in the protection key, the first data used for permission to use software installed in the information processor;
storing second data in a second storage area of the memory, the second data being the same as data stored in another protection key for permission to use other software installed in the information processor;
determining whether the second data is valid;
transmitting the second data to the information processor when the second data is valid; and
transmitting the first data to the information processor when the second data is invalid.

6. The method for reissuance of a protection key of claim 5, wherein
the first data is a unique product number according to the protection key, and
the second data is a unique dongle data for the other software.

7. The method for reissuance of a protection key of claim 5, wherein
the first data is a first key identification which is an initial value of a chaos function for the software, and
the second data is a second key identification which is another initial value of the chaos function for the other software.

8. The method for reissuance of a protection key of claim 7, further comprising:
generating a plurality of pseudo random numbers based on the chaos function; and
transmitting an encryption key including the pseudo random numbers generated based on one initial value of the first key identification and the second key identification for the chaos function to the information processor.
